(19) United States
(12) Patent Application Publication
(10) Pub. No.: US 2026/0281811 A1
(43) Pub. Date: Sep. 17, 2026

(54) REQUESTING NODES FOR A SPECIFIC TYPE OF SENSING FEEDBACK FOR DATA FUSION

(71) Applicants: Koninklijke KPN N.V., Rotterdam (NL); Nederlandse Organisatie Voor Toegepast-Natuurwetenschappelijk Onderzoek TNO, 's-Gravenhage (NL)

(72) Inventors: Sakshi Agarwal, Delft (NL); Kallol Das, Waddinxveen (NL); Remco Litjens, Voorschoten (NL); Haibin Zhang, Voorburg (NL)

(21) Appl. No.: 19/166,363

(22) PCT Filed: Mar. 20, 2024
(86) PCT No.: PCT/EP2024/057480

§ 371 Date: Sep. 17, 2025

(30) Foreign Application Priority Data
Mar. 29, 2023 (EP) 23165077.1

(51) Int. Cl. H04W 28/08; H04W 4/02

(52) U.S. Cl. CPC H04W 28/08; H04W 4/02

(57) ABSTRACT

A node (11-12,31-33) for participating in sensing is configured to receive wireless signals, e.g. from another node (11-12,31-33), for the purpose of sensing, e.g. for the purpose of sensing one or more objects (9), and receive, from a system (1) for sensing, an instruction to provide sensing feedback. The received wireless signals comprise received versions of the wireless signals as transmitted and the instruction indicates a type of sensing feedback requested from the node. The instruction may be an instruction to provide initial sensing feedback or an instruction to provide additional sensing feedback. The node is further configured to transmit sensing feedback of the indicated type to the system for sensing. The sensing feedback is determined based on the received wireless signals.

### FIELD OF THE INVENTION

The invention relates to a system for sensing and a node for participating in sensing.

The invention further relates to a method of sensing and a method of participating in sensing.

The invention also relates to computer program products enabling a computer system to perform such a method.

### BACKGROUND OF THE INVENTION

The ever increasing number of connected nodes in the cellular networks (e.g. 3/4/5G, emerging 6G networks) provides a huge potential for joint communication and sensing. On one hand, this means improved sensing performance through multi-static, multi-carrier sensing techniques which are not present in the traditional radar systems. On the other hand, this brings additional challenges in terms of complexity in the processing and increased network traffic.

Sensor data fusion to improve sensing performance is a well-researched topic. An overview of this research topic is presented in “Data Fusion and Remote Sensing: An ever-growing relationship” by M. Schmitt and X. X. Zhu, published in IEEE Geoscience and Remote Sensing Magazine, vol. 4, no. 4, pp. 6-23, December 2016. However, this paper does not consider efficient sensing data collection methods for data fusion.

While the increasing number of nodes and the density mean better and increasing sensing opportunity (in addition to communications), forwarding all of the (sensed) information as sensing feedback from a receiver to a fusion center may impose very high uplink (in case of a mobile station as sensing receiver) or backhaul (in case of a base station as a sensing receiver) traffic loads. Furthermore, this may not only take up network resources but also processing resources of the sensing nodes. Thus, although the sensing requirements may be met when all sensed information is fed back, they may not be met efficiently.

### SUMMARY OF THE INVENTION

It is a first objective of the invention to provide a node for participating in sensing, which is able to efficiently meet sensing requirements.

It is a second objective of the invention to provide a system for sensing, which is able to efficiently meet sensing requirements.

It is a third objective of the invention to provide a method of participating in sensing, which can be used to efficiently meet sensing requirements.

It is a fourth objective of the invention to provide a method of sensing, which can be used to efficiently meet sensing requirements.

In a first aspect of the invention, a node for participating in sensing includes at least one processor configured to receive wireless signals for the purpose of sensing, the received wireless signals comprising received versions of the wireless signals as transmitted, receive, from a system for sensing, an instruction to provide sensing feedback, the instruction indicating a type of sensing feedback requested from the node, and transmit sensing feedback of the indicated type to the system for sensing, the sensing feedback being determined based on the received wireless signals.

The sensing feedback may be initial sensing feedback or additional sensing feedback, for example. By letting the system for sensing, e.g. a fusion center, transmit instructions that indicate a type of sensing feedback requested from the node, the node only needs to transmit sensing feedback which is expected to help the system determine sensing results that meet the sensing requirements, thereby allowing the sensing results to be determined in a manner that is efficient in terms of consumed resources, e.g. communication resources in the feedback and/or processing resources in the system and/or nodes. The system for sensing may be one of the sensing nodes or a standalone system.

The system typically senses characteristics of the environment and/or objects within the environment. The node typically participates in sensing characteristics of the environment and/or objects within the environment. The received wireless signals typically reflect an impact of one or more objects and/or the environment on the wireless signals as transmitted. The node may be a node of a joint communication and sensing system. In other words, the node may also transmit and/or receive signals for the purpose of communication. The instruction may indicate multiple types of sensing feedback requested from the node. The at least one processor may be configured to transmit sensing feedback of multiple indicated types.

Optionally, the system may select a subset of a collection of nodes from which it requests sensing feedback. The nodes themselves may not be in a position to judge whether or not their information would be beneficial for the sensing task. Furthermore, if one or more of the nodes have already provided feedback or feedback of a higher level, another node may not need to provide feedback or feedback of the same level. The system, e.g. the fusion center, only needs to request sensing feedback which has the details that it expects will help it determine sensing results which meet the sensing requirements. As a result, the amount of consumed network resources, and possibly processing resources, may be reduced compared to if all of the sensed information would be transmitted by the nodes as sensing feedback and the sensing requirements may be met efficiently. The nodes may be able to provide multiple levels of feedback, a higher level having more detailed and/or extensive content than a lower level. In that case, the system only needs to request the level of feedback it expects will help it determine sensing results which meet the sensing requirements.

A node may be a UE (User Equipment) or a BS (Base Station), for example. The node may not only receive the wireless signals but also transmit these wireless signals (in this case, the sensing is monostatic) and/or transmit different wireless signals, e.g. specifically for the purpose of sensing (in this case, the wireless signals transmitted by the node are received by another sensing node and the sensing is bi-static). The wireless signals may be dedicated sensing signals, a waveform which has been designed for both communication and sensing, or a waveform which has not been designed for sensing but only for communication. The latter has an advantage that an anyway transmitted communications signal may be exploited for an additional purpose, i.e. for a sensing task. On the other hand, when dedicated sensing signals are specifically emitted for a given sensing task, resources are explicitly consumed by the sensing task and hence may be unavailable for performing communications tasks by one or more nodes.

The above-mentioned sensing feedback may be additional sensing feedback and the at least one processor may be configured to transmit initial sensing feedback preceding the additional sensing feedback to the system for sensing. The initial sensing feedback may include one or more flags indicative of the type of additional sensing feedback which can be obtained from the node. This allows nodes to first identify, as the initial feedback, which type of sensing feedback they are able and/or willing to transmit, and optionally transmit other lower level feedback, e.g. one or more values indicating a detected presence of possible object(s)/target(s) and/or indicating whether the IQ-level SNR exceeds/does not exceed a threshold, and the system may then determine which type of sensing feedback to request from which node in order to determine the sensing results such that the sensing requirements are met. This helps meet the sensing requirements efficiently.

The initial sensing feedback may comprise sensing feedback determined based on the received wireless signals. For example, the initial sensing feedback may comprise one or more values indicating a detected presence of possible object(s)/target(s) and/or indicating whether the IQ-level SNR exceeds/does not exceed a threshold. In this case, the initial sensing feedback and the additional sensing feedback are determined from the same received wireless signals. The additional sensing feedback is typically higher level feedback and may comprise IQ samples, for example. Optionally, the additional feedback is determined at the same time as the initial feedback but only transmitted when requested by the system, e.g. the fusion center.

The at least one processor may be configured to receive, from the system for sensing, an initial instruction to provide the initial sensing feedback, the initial instruction indicating an initial type of sensing feedback requested from the node, and transmit the initial sensing feedback by transmitting initial sensing feedback of the indicated initial type. The initial instruction may specify the content of the one or more flags if flags are requested. Alternatively, the at least one processor may be configured to determine and transmit the initial sensing feedback without receiving an initial instruction first. In this case, the type of initial sensing feedback a node should transmit may be pre-configured in the node. The initial sensing feedback may or may not comprise flags.

The at least one processor may be configured to store raw data representative of the received wireless signals in a memory, determine the sensing feedback based on the stored raw data, and remove the raw data from the memory after a predetermined amount of time or upon receiving a release instruction e.g. from the system for sensing. Thus, the raw data may be re-processed when the system, e.g. the fusion center, transmits an instruction to transmit additional sensing feedback and may be removed when re-processing is no longer required.

The at least one processor may be configured to determine the one or more flags based on at least one of: a processing load of the node, a battery level of the node, capabilities of the node, the strength of the received wireless signals, and the availability of sensing-related information. Thus, the one or more flags represent which type of sensing feedback the node is able and/or willing to transmit. Sensing-related information may include sensing task-oriented information and/or sensing assistance information.

The at least one processor may be configured to receive sensing-related information from the system for sensing, and receive the wireless signals according to the sensing-related information and/or determine the sensing feedback based on the received wireless signals according to the sensing-related information.

The sensing-related information may be indicative of one or more of: one or more thresholds, a sensing window, transmission times of the wireless signals, one or more waveforms of the wireless signals, locations of nodes which transmit the wireless signals, and data relating to one or more target areas collected by other sensors, for example. The one or more thresholds may comprise a signal energy threshold, a plot-level SNR threshold, a probability of detection threshold and/or a probability of false alarm threshold, for example.

This sensing-related information helps the node ensure that it receives the most relevant parts of the wireless signals such that better sensing feedback can be determined and/or helps the node process the received wireless signals such that it can determine better sensing feedback.

In a second aspect of the invention, a system for sensing comprises at least one processor configured to obtain sensing requirements for sensing, receive sensing feedback from each of a set of nodes, determine whether the sensing requirements can be met when a sensing result is determined based on the received sensing feedback, and if the sensing requirements cannot be met when the sensing result is determined based on the received sensing feedback, a) determine at least one instruction for at least one node of the set of nodes based on the sensing requirements and the received sensing feedback, b) transmit the at least one instruction to the at least one node, the at least one instruction requesting additional sensing feedback from the at least one node and indicating a type of additional sensing feedback requested from the at least one node, c) receive the additional sensing feedback from the at least one node, and d) determine the sensing result based on at least the additional sensing feedback.

Typically, nodes first transmit lower level feedback, e.g. one or more flags, as (initial) sensing feedback and then higher level feedback as additional sensing feedback. The system, e.g. the fusion center, only needs to request additional sensing feedback which has the details that the system expects will help it determine sensing results which meet the sensing requirements. As a result, the amount of consumed network resources, and possibly processing resources, may be reduced compared to if all of the sensed information would be transmitted by the nodes as sensing feedback and the sensing requirements may be met efficiently.

As discussed above, the system may select a subset of a collection of nodes from which it requests sensing feedback. After this selection, the system may tell the selected nodes to start sensing, e.g. at the same time that it transmits initial instructions and/or sensing-related information. The system for sensing may be one of the sensing nodes or a standalone system.

The sensing requirements may, for example, specify one or more of: one or more targeted areas, one or more targeted directions, one or more targeted object types, one or more targeted objects (e.g. one or more object identifiers), one or more targeted object velocities, one or more targeted object sizes, and one or more sensing performance requirements. The one or more sensing performance requirements may specify requirements on sensing accuracy, sensing urgency, and/or sensing reliability, for example. The sensing accuracy requirement may comprise a targeted range resolution, for example. The sensing reliability requirement may comprise a minimum likelihood of detection and/or a limit on the false alarm rate, for example.

Determining the sensing results typically comprises determining physical properties of one or more objects and/or of the environment. The physical properties of the one or more objects that are targets for the sensing task may include one or more of shape, size, velocity, distance, location, orientation, type of material, color, temperature, heartbeat, pitch, yaw, and roll, for example.

The at least one processor of the system may be configured to determine the at least one instruction further based on one or more of network conditions, node capabilities, regulatory requirements, and operator policies. Network conditions may comprise one or more of geometry, topology, location of the nodes, network load, processing load, and energy consumption, for example. The network load may comprise sensing load and/or communication load. Node capabilities may comprise one or more of processing power, antenna configurations, and transmission/reception capability of the nodes, for example. Regulatory requirements may include transmission power limit on particular frequency bands, for example. Operator policies may include prioritization among different services (e.g. sensing services, communication services), for example.

The at least one processor of the system may be configured to determine initial instructions for at least one node of the set of nodes based on the sensing requirements, the initial instructions requesting the sensing feedback from the at least one node, transmit the initial instructions to the at least one node, and receive the sensing feedback from the at least one node in response to the initial instructions. Alternatively, one or more of the nodes may be configured to determine and transmit the initial sensing feedback without receiving an initial instruction first. In this case, the type of initial sensing feedback a node should transmit may be pre-configured in the node. The at least one processor of the system may be configured to determine the initial instructions further based on one or more of network conditions, node capabilities, regulatory requirements, and operator policies.

The sensing feedback received from a respective node of the set of nodes may include one or more flags indicative of the type of additional sensing feedback which can be obtained from the respective node and the at least one processor of the system may be configured to determine the at least one instruction based on the sensing requirements and the one or more flags. This allows nodes to first indicate which type of sensing feedback they are able and/or willing to transmit, and optionally transmit other lower level sensing feedback, and the system, e.g. the fusion center, may then determine which type of additional sensing feedback has the details that the system expects will help it determine sensing results that meet the sensing requirements. The system only needs to request sensing feedback which has the details that it expects will help it determine sensing results which meet the sensing requirements. This helps meet the sensing requirements efficiently.

The at least one processor may be configured to transmit sensing-related information to at least one node of the set of nodes. The sensing-related information may be indicative of one or more of: one or more thresholds, a sensing window, transmission times of the wireless signals, one or more waveforms of the wireless signals, locations of nodes which transmit the wireless signals, and data relating to one or more target areas collected by other sensors, for example.

In a third aspect of the invention, a method of participating in sensing includes receiving wireless signals for the purpose of sensing, the received wireless signals comprising received versions of the wireless signals as transmitted, receiving, from a system for sensing, an instruction to provide sensing feedback, the instruction indicating a type of sensing feedback requested from the node, and transmitting sensing feedback of the indicated type to the system for sensing, the sensing feedback being determined based on the received wireless signals. The method may be performed by software running on a programmable device. This software may be provided as a computer program product.

In a fourth aspect of the invention, a method of sensing includes obtaining sensing requirements for sensing, receiving sensing feedback from each of a set of nodes, determining whether the sensing requirements can be met when a sensing result is determined based on the received sensing feedback, and if the sensing requirements cannot be met when the sensing result is determined based on the received sensing feedback, a) determining at least one instruction for at least one node of the set of nodes based on the sensing requirements and the received sensing feedback, b) transmitting the at least one instruction to the at least one node, the at least one instruction requesting additional sensing feedback from the at least one node and indicating a type of sensing feedback requested from the at least one node, c) receiving the additional sensing feedback from the at least one node, and d) determining the sensing result based on at least the additional sensing feedback. The method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least a first software code portion, the first software code portion, when executed or processed by a computer, being configured to perform executable operations for participating in sensing.

The executable operations include receiving wireless signals for the purpose of sensing, the received wireless signals comprising received versions of the wireless signals as transmitted, receiving, from a system for sensing, an instruction to provide sensing feedback, the instruction indicating a type of sensing feedback requested from the node, and transmitting sensing feedback of the indicated type to the system for sensing, the sensing feedback being determined based on the received wireless signals.

A non-transitory computer-readable storage medium stores at least a second software code portion, the second software code portion, when executed or processed by a computer, being configured to perform executable operations for sensing.

The executable operations include receiving sensing feedback from each of a set of nodes, determining whether the sensing requirements can be met when a sensing result is determined based on the received sensing feedback, and if the sensing requirements cannot be met when the sensing result is determined based on the received sensing feedback, a) determining at least one instruction for at least one node of the set of nodes based on the sensing requirements and the received sensing feedback, b) transmitting the at least one instruction to the at least one node, the at least one instruction requesting additional sensing feedback from the at least one node and indicating a type of sensing feedback requested from the at least one node, c) receiving the additional sensing feedback from the at least one node, and d) determining the sensing result based on at least the additional sensing feedback.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s).

It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of an embodiment of the system and of embodiments of the node;

FIG. 2 shows the nodes of FIG. 1 in an example situation;

FIG. 3 is a flow diagram of a first embodiment of the method of participating in sensing;

FIG. 4 is a flow diagram of a first embodiment of the method of sensing and a second embodiment of the method of participating in sensing;

FIG. 5 is a flow diagram of a second embodiment of the method of sensing and a third embodiment of the method of participating in sensing;

FIG. 6 is a flow diagram of a third embodiment of the method of sensing and a fourth embodiment of the method of participating in sensing; and

FIG. 7 is a block diagram of an exemplary data processing system for performing the method of the invention.

Corresponding elements in the drawings are denoted by the same reference numeral.

### DETAILED DESCRIPTION OF THE DRAWINGS

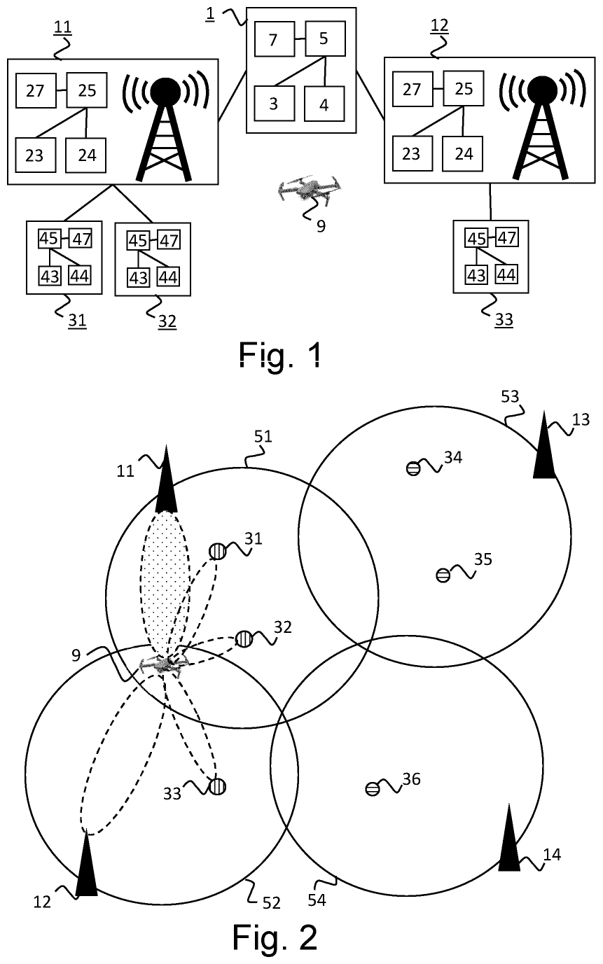

FIG. 1 is a block diagram of an embodiment of a system for sensing and two embodiments of a node for participating in sensing. These nodes for participating in sensing are adapted to participate in the sensing. There may also be nodes that participate in sensing without being adapted to do so, e.g. by transmitting communication signals as usual. These nodes are not present in the example of FIG. 1. Both types of nodes are jointly referred to as sensing nodes in this specification. In this embodiment of the system for sensing, the system for sensing is not one of the sensing nodes, but a standalone system 1, and the sensing nodes are nodes of a joint communication and sensing system. The system 1 may be fusion center, for example.

Two types of sensing nodes are shown in FIG. 1: sensing nodes 11-12 are BSs and sensing nodes 31-33 are UEs. The large number of nodes (BSs and UEs) and their large density in a mobile network provides an excellent opportunity for sensing in addition to communication. The network operator may assign the task of sensing to a number of nodes of the mobile network, i.e. may appoint sensing transmitter(s) and/or sensing receiver(s), by using some method.

In the example of FIG. 1, UEs 31 and 32 are connected to the base station 11 and UE 33 is connected to the base station 12. In the example of FIG. 1, the UEs 31-33 are connected to base stations which are also sensing nodes. However, a UE may be a sensing node even if it is connected to a base station which is not a sensing node. The UEs 31-33 may communicate with the system 1 via the base stations 11 and 12. The base stations 11 and 12 may comprise a plurality of distributed units that share a common centralized unit in a Centralized RAN (C-RAN) architecture, for example.

The system 1 typically senses characteristics of the environment and/or objects within the environment, e.g. object 9. The sensing nodes 11-12,31-33 typically participate in sensing characteristics of the environment and/or objects within the environment. The wireless signals received at the sensing nodes 11-12,31-33 typically reflect an impact of one or more objects and/or the environment on the wireless signals as transmitted.

A sensing node may not only receive the wireless signals but also transmit these wireless signals (in this case, the sensing is monostatic) and/or transmit different wireless signals, e.g. specifically for the purpose of sensing (in this case, the wireless signals transmitted by the sensing node are received by another sensing node and the sensing is bi-static). The wireless signals may be dedicated sensing signals, a waveform which has been designed for both communication and sensing, or a waveform which has not been designed for sensing but only for communication.

The base stations 11 and 12 each comprise a receiver 23, a transmitter 24, a processor 25, and a memory 27. The UEs 31-33 each comprise a receiver 43, a transmitter 44, a processor 45, and a memory 47. The processor 25 and the processor 45 are each configured to receive wireless signals for the purpose of sensing and receive, from system 1, an instruction to provide sensing feedback. The received wireless signals comprise received versions of the wireless signals as transmitted, e.g. by another node, and the instruction indicates a type of sensing feedback requested from the node which receives this instruction.

The processor 25 and the processor 45 are further configured to transmit sensing feedback of the indicated type to the system 1. The sensing feedback is determined based on the received wireless signals. In the embodiment of FIG. 1, the received instruction is an instruction to provide additional sensing feedback from the system 1 and the processor 25 and 45 are configured to transmit, in addition to the (additional) sensing feedback, initial sensing feedback preceding the additional sensing feedback to the system 1. The processor 25 and the processor 45 may be pre-configured to transmit this initial sensing feedback or may be configured to transmit this initial sensing feedback in response to receiving an initial instruction from the system 1.

The system 1 comprises a receiver 3, a transmitter 4, a processor 5, and a memory 7. The processor 5 is configured to obtain sensing requirements for sensing, receive (initial) sensing feedback from each of a set of nodes, e.g. from one or more of nodes 11-12,31-33, and determine whether the sensing requirements can be met when a sensing result is determined based on the received sensing feedback. The set of nodes may be a subset of a larger collection of nodes. For example, the set of nodes may comprise nodes 31 and 32 and the larger set of nodes may comprise nodes 11-12,31-33. The processor 5 is further configured to, if the sensing requirements cannot be met when the sensing result is determined based on the received sensing feedback, determine at least one instruction for at least one node of the set of nodes based on the sensing requirements and the received sensing feedback and transmit the at least one instruction to the at least one node.

The at least one instruction requests additional sensing feedback from the at least one node and indicates a type of additional sensing feedback requested from the at least one node. The processor 5 is further configured to receive the additional sensing feedback from the at least one node and determine the sensing result based on at least the additional sensing feedback.

In the embodiment shown in FIG. 1, the system 1 comprises one processor. In an alternative embodiment, the system 1 comprises multiple processors. The processor 5 may be a general-purpose processor, e.g., an Intel or an AMD processor, or an application-specific processor, for example. The processor 5 may comprise multiple cores, for example. The processor 5 may run a Unix-based or Windows operating system, for example. The memory 7 may comprise solid state memory, e.g., one or more Solid State Disks (SSDs) made out of Flash memory, or one or more hard disks, for example.

The receiver 3 and the transmitter 4 may use one or more wired or wireless communication technologies to communicate with base stations 11 and 12. The receiver 3 and the transmitter 4 may use one or more communication technologies (wired or wireless) to communicate with other systems in the radio access network or in the core network, for example. The receiver 3 and the transmitter 4 may be combined in a transceiver. The system 1 may comprise other components typical for a component in a mobile communication network, e.g., a power supply. In the embodiment of FIG. 1, system 1 is a standalone system. In an alternative embodiment, system 1 is co-located with one of base stations 11 and 12.

In the embodiment shown in FIG. 1, the base stations 11 and 12 comprise one processor. In an alternative embodiment, one or more of the base stations 11 and 12 comprise multiple processors. The processor 25 of the base stations 11 and 12 may be a general-purpose processor, e.g., an Intel or an AMD processor, or an application-specific processor, for example. The processor 25 may comprise multiple cores, for example. The processor 25 may run a Unix-based or Windows operating system, for example. The memory 27 may comprise solid state memory, e.g., one or more Solid State Disks (SSDs) made out of Flash memory, or one or more hard disks, for example.

The receiver 23 and the transmitter 24 may use one or more wireless communication technologies such as Wi-Fi, LTE, and/or 5G New Radio to communicate with UEs 31-33. The receiver 23 and the transmitter 24 may use one or more communication technologies (wired or wireless) to communicate with other systems, e.g. system 1, in the radio access network or in the core network, for example. The receiver 23 and the transmitter 24 may be combined in a transceiver. The base stations may comprise other components typical for a component in a mobile communication network, e.g., a power supply. In the embodiment shown in FIG. 1, each of the base stations may comprise a single unit or a central unit and one or multiple distributed units, for example.

In the embodiment shown in FIG. 1, the UEs 31-33 comprise one processor 45. In an alternative embodiment, one or more of the UEs 31-33 comprise multiple processors. The processor 45 may be a general-purpose processor, e.g., an ARM or Qualcomm processor, or an application-specific processor. The processor 45 may run Google Android or Apple iOS as operating system, for example.

The receiver 43 and the transmitter 44 of the UEs 31-33 may use one or more wireless communication technologies such as Wi-Fi, LTE, and/or 5G New Radio to communicate with base stations, for example. The receiver 43 and the transmitter 44 may be combined in a transceiver. The UEs 31-33 may comprise other components typical for user equipment, e.g., a battery and/or a power connector.

A UE may also be referred to by those skilled in the art as a mobile station (MS), a subscriber station, a mobile unit, a subscriber unit, a wireless unit, a wireless terminal, a wireless device, a wireless communications device, a remote device, a mobile subscriber station, an access terminal (AT), a mobile terminal, a remote terminal, a handset, a terminal, a user agent, a mobile client, a client, or some other suitable terminology.

FIG. 2 shows the nodes 11-12, 31-33 of FIG. 1 and further nodes 13-14, 34-36 in an example situation. The example of FIG. 2 shows four base stations 11-14, their respective coverage areas 51-54, six UEs 31-36, and object 9. In the example of FIG. 2, each base station provides coverage to a single cell. In another example, one or more of the base stations each provides coverage to multiple cells.

In view of the location of target object 9, node 11 has been selected as transmitting node and nodes 12,31-33 have been selected as receiving nodes. Nodes 13-14,34-36 have not been selected, because they are too far away from the target object 9. The wireless signal transmitted by node 11 is impacted by the object 9, e.g. due to reflection, diffraction, and/or scattering. The nodes 12,31-33 receive the impacted signals, e.g. the reflections/echoes.

Dedicated sensing signals may affect communication performance and may consume additional resources. If supported, it may be beneficial to avoid their use where possible. Instead, wireless signals with communication payload and/or communication reference signals may be simultaneously used for the purposes of communication and sensing.

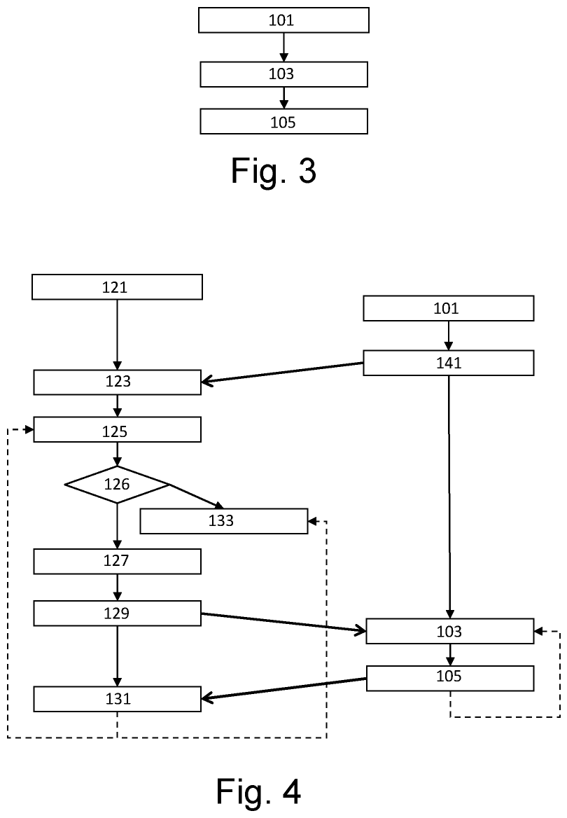

A first embodiment of the method of participating in sensing is shown in FIG. 3. A step 101 comprises receiving wireless signals for the purpose of sensing. The received wireless signals comprise received versions of the wireless signals as transmitted. A step 103 comprises receiving, from a system for sensing, an instruction to provide sensing feedback. The instruction indicates a type of sensing feedback requested from the node. A step 105 comprises transmitting sensing feedback of the indicated type to the system for sensing. The sensing feedback is determined based on the received wireless signals.

A first embodiment of the method of sensing and a second embodiment of the method of participating in sensing are shown in FIG. 4. The second embodiment of the method of participating in sensing, as shown in FIG. 4, is an extension of the first embodiment of the method of participating in sensing, as shown in FIG. 3. In the embodiment of FIG. 4, the sensing feedback transmitted in step 105 is additional sensing feedback.

A step 121 comprises a system obtaining sensing requirements for sensing. The sensing requirements may, for example, specify one or more of: one or more targeted areas, one or more targeted directions, one or more targeted object types, one or more targeted objects (e.g. one or more object identifiers), one or more targeted object velocities, one or more targeted object sizes, and one or more sensing performance requirements. The one or more sensing performance requirements may specify requirements on sensing accuracy, sensing urgency, and/or sensing reliability, for example. The sensing accuracy requirement may comprise a targeted range resolution, for example. The sensing reliability requirement may comprise a minimum likelihood of detection and/or a limit on the false alarm rate, for example.

Step 101 comprises a node receiving wireless signals for the purpose of sensing. The received wireless signals comprise received versions of the wireless signals as transmitted. A step 141 comprises the node transmitting initial sensing feedback to the system. A step 123 comprises the system receiving initial sensing feedback from each of a set of nodes. This set of nodes comprises the node.

A step 125 comprises the system determining whether the sensing requirements can be met when a sensing result is determined based on the received sensing feedback. Determining the sensing results typically comprises determining physical properties of one or more objects and/or of the environment. The physical properties of the one or more objects that are targets for the sensing task may include one or more of shape, size, velocity, distance, location, orientation, type of material, color, temperature, heartbeat, pitch, yaw, and roll, for example.

A step 126 comprises the system checking the results of step 125. If it was determined in step 125 that the sensing requirements obtained in step 121 can be met when the sensing result is determined based on the received sensing feedback, a step 133 is performed. Step 133 comprises outputting the sensing result. Step 133 comprises determining the sensing result if the sensing result was not already determined in step 125. If steps 127-131 are not performed, the outputted sensing result is determined based on only the initial sensing feedback received in step 123.

If it was determined in step 125 that the sensing requirements cannot be met when the sensing result is determined based on the received sensing feedback, step 127 is performed. Step 127 comprises the system determining at least one instruction for at least one node of the set of nodes based on the sensing requirements obtained in step 121 and the sensing feedback received e.g. in step 123. This at least one node comprises the node. A step 129 comprises the system transmitting the at least one instruction to the at least one node, including the node. The at least one instruction requests additional sensing feedback from the at least one node and indicates a type of sensing feedback requested from the at least one node.

Step 103 comprises the node receiving, from the system, the instruction to provide sensing feedback. Step 105 comprises the node transmitting additional sensing feedback of the indicated type to the system. The additional sensing feedback is determined based on the wireless signals received in step 101. A step 131 comprises the system receiving the additional sensing feedback from the at least one node, including the node.

Step 125 may be repeated after step 131. In this next iteration of step 125, step 125 comprises the system determining whether the sensing requirements obtained in step 121 can be met when the sensing result is determined based on at least the additional sensing feedback received in step 131 (and optionally based on previously received sensing feedback(s)). If so, then step 133 is performed. The outputted sensing result is then based on at least the additional sensing feedback received in step 131.

Steps 127-131 are repeated if it was determined in step 125 that the sensing requirements cannot be met when the sensing result is determined based on at least the additional sensing feedback received in step 131. Steps 127-131 may be repeated one time or multiple times, e.g. until no further improvement on the sensing result is expected through further feedback. In these next iterations of steps 127-131, the at least one node to which the at least one instruction is transmitted might or might not include the node (to which the at least one instruction was transmitted in the first iteration of steps 127-131). If step 125 is not repeated after step 131 (not at all or not another time), step 133 is performed after step 131.

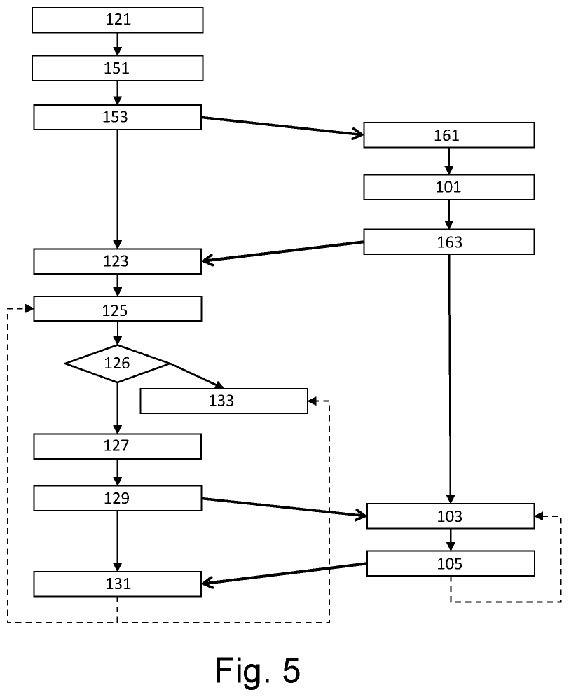

A second embodiment of the method of sensing and a third embodiment of the method of participating in sensing are shown in FIG. 5. The embodiments of FIG. 5 are an extension of the embodiments of FIG. 4. In the embodiments of FIG. 5, the system performs steps 151 and 153 between steps 121 and 123 and the node performs a step 161 before step 101 and a step 163 between steps 101 and 103.

Step 121 comprises the system obtaining sensing requirements for sensing. Step 151 comprises the system determining initial instructions for at least one node based on the sensing requirements obtained in step 121. The initial instructions request the initial sensing feedback from the at least one node. The initial instructions may further be determined based on one or more of network conditions, node capabilities, regulatory requirements, and operator policies in step 151.

Network conditions may comprises one or more of geometry, topology, location of the nodes, network load, processing load, and energy consumption, for example. The network load may comprise sensing load and/or communication load. Node capabilities may comprise one or more of processing power, antenna configurations, and transmission/reception capability of the nodes, for example. Regulatory requirements may include transmission power limit on particular frequency bands, for example. Operator policies may include prioritization among different services (e.g. sensing services, communication services), for example.

Step 153 comprises the system transmitting the initial instructions to the at least one node. If the initial instructions are further determined based on one or more of network conditions, node capabilities, regulatory requirements, and operator policies, then the result of step 151 may be that no initial instructions are transmitted. Performance of the method of FIG. 5 may then be paused and resumed at a later time, starting with performing step 151 or step 121 again.

Step 161 comprises the node receiving, from the system, the initial instruction to provide the initial sensing feedback. The initial instruction indicates an initial type of sensing feedback requested from the node. Step 101 comprises the node receiving the wireless signals for the purpose of sensing. Step 163 comprises the node transmitting initial sensing feedback of the indicated initial type.

Step 123 comprises the system receiving initial sensing feedback from each node of a set of nodes. Step 123 comprises the system receiving the sensing feedback from the at least one node, including the node, in response to the initial instructions. If there are one or more nodes in the set of nodes to which no initial instructions are transmitted, these one or more nodes may be pre-configured to transmit initial sensing feedback of a pre-configured initial type. The method then proceeds as shown in FIG. 5 and described in relation to FIG. 4.

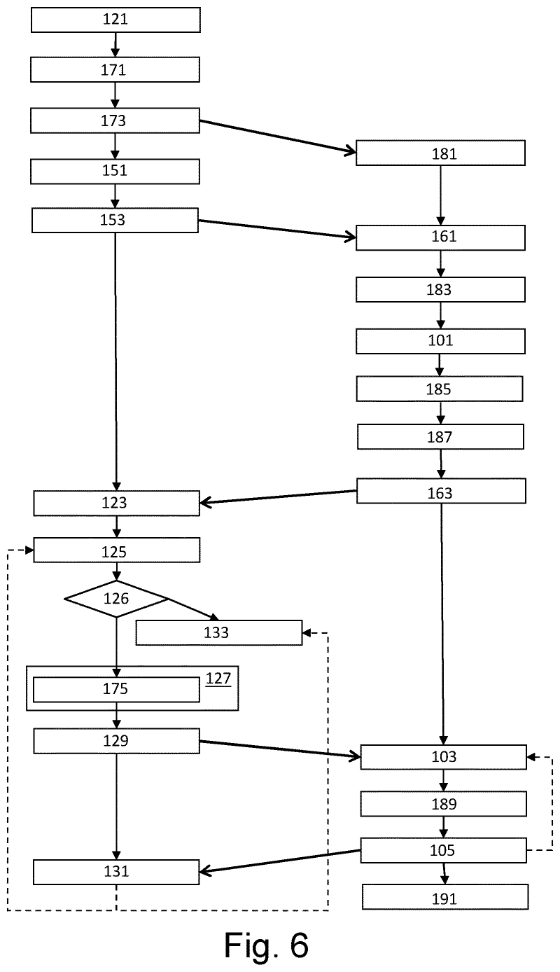

A third embodiment of the method of sensing and a fourth embodiment of the method of participating in sensing are shown in FIG. 6. The embodiments of FIG. 6 are an extension of the embodiments of FIG. 5.

Step 121 comprises the system obtaining sensing requirements for sensing. A step 171 comprising the system selecting a set of nodes from which it wants to request sensing feedback. The set of nodes is a subset selected from a collection of nodes. Optionally, step 171 may further comprise selecting a further set of nodes to which it wants to transmit a request to transmit wireless signals for the purpose of sensing, e.g. if dedicated sensing signals should be transmitted. This further set of nodes, e.g. comprising the nodes transmitting dedicated sensing signals, is a subset selected from the same collection of nodes or from a different collection of nodes. The steps performed by the transmitting nodes for transmitting wireless signals are not shown in FIG. 6.

A step 173 comprise informing the set of nodes, and optionally the further set of nodes, of their appointment and optionally their role. Step 181 comprises a node receiving this appointment information from the system. In the example of FIG. 2, base station 11 is appointed as the designated transmitter and base station 12 and UEs 31-33 are appointed as designated receivers for a particular sensing task (in this case to detect the target object 9).

In an alternative embodiment, all nodes from the collection of nodes always participate in the sensing and no appointment information needs to be transmitted. In a different embodiment, the task of appointing sensing transmitter(s) and sensing receiver(s) may be performed by a different system, e.g. of the network operator.

Step 151 comprises the system determining initial instructions for at least one of the selected set of nodes based on the sensing requirements obtained in step 121, e.g. based on accuracy and urgency requirements. The initial instructions request the initial sensing feedback from the at least one node.

In the embodiment of FIG. 6, the nodes are able to provide multiple levels of feedback. A higher level has more detailed and/or extensive content than a lower level. More extensive content may comprise IQ samples of the detected echoes/reflections, for example. More detailed content may comprise, for example, results of local sensing, e.g. a probability of detection, a probability of false-alarm, and/or object attributes (e.g. shape, orientation) if the probability of detection exceeds a threshold and the probability of false-alarm does not exceed a threshold.

If the sensing task is resource critical, the level of detail requested in the initial instructions is preferably low. The system only needs to request the level of feedback it expects will help it determine sensing results which meet the sensing requirements. The initial instructions may specify the content of one or more flags that the system wants to receive as part of the initial sensing feedback and may optionally specify which other lower level feedback the system wants to receive as part of the initial sensing feedback.

Step 153 comprises the system transmitting the initial instructions to the at least one node. Optionally, step 153, step 173, or another step further comprises the system transmitting sensing-related information to at least one of the set of nodes. Sensing-related information may be shared with/made available at the appointed receiving nodes through broadcast/unicast message(s) by the system or by the appointed transmitting nodes. The sensing-related information may include sensing task-oriented information and/or sensing assistance information. The sensing task-oriented information may be indicative of one or more of the following:
A. The Sensing window: This specifies when the echoes may arrive. Knowledge of this information helps the receiving nodes to identify the echoes from the original transmitted signals and optimize the (presence) detection.
B. Transmission time—This specifies the time when the sensing signal is transmitted by a transmitting node. Knowledge on this helps a receiving node to estimate the sensing window, detect presence of echoes and/or calculate the length of the path between the transmitting node and the receiving node via the object and/or environment whose characteristics are supposed to be detected.
C. Waveform of the sensing signal—Such information e.g. spreading code, could help a receiving node obtain more detailed sensing information (assuming the receiving node is capable of corresponding processing) locally without further assistance from other nodes.
D. Thresholds—By asking the receiving nodes to process the received wireless signals with certain thresholds, e.g. signal energy threshold, plot-level SNR threshold, probability of detection threshold, and/or probability of false alarm threshold, the system may be able to get the information it needs, e.g. in view of the sensing requirements, without receiving the raw data.

The sensing assistance information may be indicative of one or more of the following:
A. The location info of the transmitting nodes—Knowledge of this information helps the receiving nodes to estimate the location of the target object. This might be especially helpful when the sensing transmitters are UEs (whose locations are not always known to the receiving nodes)
B. Data about the target object/area collected by other sensors (e.g. camera)—Such information could help a receiving node obtain more detailed sensing information (assuming the receiving node is capable of corresponding processing) and/or assists in determining sensing results that meet the sensing requirements.

After the appointment of the set of nodes, the system may tell the set of nodes to start sensing, e.g. at the same time that it transmits the initial instructions and/or the sensing-related information.

Step 161 comprises the node receiving, from the system, an initial instruction to provide the initial sensing feedback. The initial instruction indicates an initial type of sensing feedback requested from the node. Optionally, step 161, step 181, or another step further comprises receiving the sensing-related information from the system. In an alternative embodiment, the initial instruction is not received from the system but statically pre-programmed in the node, e.g. according to a certain standard.

A step 183 comprises the node determining (the value(s) of) one or more flags indicative of the type of sensing feedback which can be obtained from the node, e.g. based on a processing load of the node, a battery level of the node, capabilities of the node, and/or the availability of sensing-related information. In the embodiment of FIG. 6, the node determines which flags to include in the initial sensing feedback based on the initial instructions received in step 161. In an alternative embodiment, step 183 is performed between steps 185 and 187, e.g. if the one or more flags indicative of the type of sensing feedback which can be obtained from the node are determined based on the strength of the wireless signals received in step 101.

Step 101 comprises the node receiving the wireless signals for the purpose of sensing. The wireless signals are transmitted by the (e.g. appointed) transmitting nodes. These wireless signals may be communication signals being also used for the sensing task such as SSBs of 5G NR, CSI-RSs of 5G NR, and payloads or dedicated sensing signals. The node has the ability to differentiate between the transmitted wireless signals and the reflections/echoes and listens for the reflections/echoes. If sensing-related information was received, e.g. in step 161, the wireless signals may be received in step 101 according to this sensing-related information. A step 185 comprises the node storing raw data representative of the wireless signals received in step 101 in a memory for future use.

A step 187 comprises the node determining initial sensing feedback of the indicated initial type based on the wireless signals received in step 101, e.g. based on the raw data stored in step 185. If sensing-related information was received, e.g. in step 161, the initial sensing feedback may be determined according to the sensing-related information in step 187.

In the embodiment of FIG. 6, the node is able to provide multiple levels of feedback, a higher level having more detailed and/or extensive content than a lower level. The node first transmits lower level feedback as initial sensing feedback and then, if needed, higher level feedback as additional sensing feedback. The initial sensing feedback includes one or more flags and optionally other lower level feedback, e.g. one or more values indicating a detected presence of possible object(s)/target(s) and/or indicating whether the IQ-level SNR exceeds/does not exceed a threshold.

In step 187, the node processes the raw data and derives local sensing information. The type of local sensing information (e.g. IQ samples, probability of detection) that a node may be able and/or may be willing to obtain from the wireless signals may depend on the processing load, the capability of that node, the strength of the received wireless signal and the availability of the sensing-related information. The value(s) of the one or more flags determined in step 183 reflect what kind of local sensing information the node is able to and/or willing to obtain. In step 187, the node may derive local sensing information that it is not going to include in the initial sensing feedback but only transmit in additional sensing feedback if and when requested.

As the processing of the raw data depends on the strength of the received signals (i.e. the echoes/reflections), the following scenarios may be distinguished:
a) The node is not able to distinguish the echoes/reflections from the noise (e.g. the received signal is below the noise floor). In this case, the node can transmit its IQ-samples but is unable to calculate and provide the IQ-level SNR of the echoes/reflections or perform local sensing.
b) The node is able to distinguish the echoes/reflections from the noise (e.g. the received signal is above the noise floor). In this case, the followings are possible:
   i. The received signal is not strong enough for local sensing at the node (the node is not able to clearly identify the waveform of the echo). In this case, IQ-samples can be provided and IQ-level SNR can also be calculated and provided, but not much else can be provided.
   ii. The received signal is strong enough for local sensing at the node. In this case, plot-level SNR, probability of detection and probability of false-alarm may also be calculated and provided in addition to the IQ-samples and IQ-level SNR.

Which information can be obtained from the wireless signals in scenarios b-i and b-ii may depend on the knowledge on the waveform of the wireless signals at the node. For instance, when base station 11 of FIG. 2 transmits SSBs to conduct sensing, the receiving nodes 12,31-33 of FIG. 2 may already know the waveform of such signals and might be able to estimate the transmission window. If a receiving node is able to perform local sensing without further assistance from other nodes and has sufficient processing capability, it may be able to obtain detailed sensing information (e.g. plot-level SNR, probability of detection, probability of false-alarm, object attributes) from the wireless signals (scenario b-ii).

However, when base station 11 of FIG. 2 transmits dedicated sensing signals or sensing signals which are not known to the receiving nodes 12,31-33 of FIG. 2 (e.g. payload signals intended for UEs that are not a sensing receiver), the receiving nodes may not be able to obtain equally detailed sensing information from the wireless signals (scenario b-i).

After deriving the local sensing information, the node prepares the initial sensing feedback of the indicated initial type determined in step 187. The initial sensing feedback typically comprises lower level feedback to meet the sensing requirements efficiently. In the embodiment of FIG. 6, the initial sensing feedback comprises the one or more flags determined in step 183. The one or more flags may indicate, for example, IQ samples available: yes/no, IQ-level SNR available yes/no, plot-level SNR available: yes/no. In an alternative embodiment, the initial sensing feedback does not include any such flags.

The initial sensing feedback may include other lower level feedback, e.g. one or more values indicating a detected presence of possible object(s)/target(s) and/or indicating whether the IQ-level SNR exceeds/does not exceed a threshold. Step 163 comprises the node transmitting the initial sensing feedback.

Step 123 comprises the system receiving initial sensing feedback from at least one node of the set of nodes. Step 123 comprises the system receiving the initial sensing feedback from the at least one node, including the node, in response to the initial instructions. If there are one or more nodes in the set of nodes to which no initial instructions are transmitted, these one or more nodes may be pre-configured to transmit initial sensing feedback of a pre-configured initial type. The initial sensing feedback received from the node includes the one or more flags indicative of the type of available sensing feedback which can be obtained from the node and may include other lower level feedback.

Step 125 comprises the system determining whether the sensing requirements can be met when a sensing result is determined based on the received sensing feedback. Step 126 comprises the system checking the results of step 125. If it was determined in step 125 that the sensing requirements obtained in step 121 can be met when the sensing result is determined based on the received sensing feedback, step 133 is performed.

Step 133 comprises outputting the sensing result. Step 133 comprises determining the sensing result if the sensing result was not already determined in step 125. If steps 127-131 are not performed, the outputted sensing result is determined based on only the initial sensing feedback received in step 123. When step 133 is performed, the system may optionally inform the nodes from which it has requested sensing feedback, so that they can delete any raw data that they have stored (not shown in FIG. 6).

In the first iteration of step 125, the system determines whether the initial sensing feedback received from the at least one node is sufficient to meet the sensing requirements of the task. In a next iteration of step 125, the system determines whether the additional sensing feedback, optionally combined with the initial sensing feedback, is sufficient to meet the sensing requirements of the task. The following situations may occur, for example:
a) One or more of the nodes were able to perform local sensing (e.g. localizing an object) and report the results of this local sensing with high enough probability of detection(s) and/or low enough probability of false-alarm(s) such that sensing requirements are met. In such cases, no further action is needed and the system outputs the sensing result. If the goal of the sensing task cannot be fulfilled by local sensing, sensing information with adequate quality is typically needed from a sufficient number of nodes (e.g. at least three nodes for 2D-positioning).
b) One or more of the nodes were able to perform local sensing and report the results of this local sensing with high enough probability of detection(s) but also with a high probability of false-alarm(s). In such cases, the ambiguity of the detection might be reduced from the fact that same object/event is detected by multiple nodes which are spatially distributed. The system may not need to collect any further information in such cases. However, if the collected information is not sufficient to resolve the ambiguity (for instance, when the nodes are located in the same region, i.e. not spatially distributed), the system may decide to request additional sensing feedback, e.g. IQ samples, from one or more nodes.
c) Each node of the set of nodes reports IQ-data and IQ-level SNRs only and no other information is available from these nodes. In this case, the system may need to request additional sensing feedback from one or more other nodes. If each node of the set of nodes reports IQ-level SNRs only but does have IQ-data available, the system may need to request additional sensing feedback including the IQ-data from one or more nodes of the set of nodes. These one or more (other) nodes may be selected based on the IQ-level SNRs and/or network conditions (e.g. geometry, topology, location of the nodes, network load) and/or device capability (e.g. processing capability, battery power) information.
d) Each node of the set of nodes reports IQ-data only and no other information is available from these nodes. In this case, the system may need to request additional sensing feedback from one or more other nodes. These one or more nodes may be selected randomly or based on network conditions (e.g. geometry, topology, location of the nodes, network load) and/or device capability (e.g. processing capability, battery power) information.

If it was determined in step 125 that the sensing requirements cannot be met when the sensing result is determined based on the received sensing feedback, step 127 is performed. Step 127 comprises the system determining at least one instruction for at least one node of the set of nodes based on the sensing requirements obtained in step 121 and the sensing feedback e.g. received in step 123. This at least one node comprises the node.

The at least one instruction requests additional sensing feedback from the at least one node and indicates a type of sensing feedback requested from the at least one node. In the embodiment of FIG. 6, step 127 of FIG. 5 is implemented by a step 175. Step 175 comprises determining the instruction for the node based on the sensing requirements obtained in step 121 and the (value(s) of the) one or more flags included in the initial sensing feedback received from the node in step 123. The at least one instruction may further be determined based on one or more of network conditions, node capabilities, regulatory requirements, and operator policies in step 175.

If the sensing requirements cannot be met (yet), the system asks the at least one node for additional sensing feedback and optionally asks one or more other nodes for sensing feedback. For example, if only few or none of the set of nodes detect signals with high enough SNR, the system may ask at least one of the set of nodes to share IQ-samples for more accurate/better sensing.

While requesting additional sensing feedback, the system may also choose to provide additional sensing-related information to the at least one node (e.g. sensing waveform (C), updated threshold(s) (D)), e.g. through a unicast message. The sensing-related information may include sensing task-oriented information and/or sensing assistance information. The decision on whether or not to share such additional sensing-related information with the at least one node and/or request additional sensing feedback from the at least one node may also take one or more of network conditions, node capabilities, regulatory requirements, and operator policies into account.

Network conditions may comprises one or more of geometry, topology, location of the nodes, network load, processing load, and energy consumption, for example. The network load may comprise sensing load and/or communication load. Node capabilities may comprise one or more of processing power, antenna configurations, and transmission/reception capability of the nodes, for example. Regulatory requirements may include transmission power limit on particular frequency bands, for example. Operator policies may include prioritization among different services (e.g. sensing services, communication services), for example.

Step 129 comprises the system transmitting the at least one instruction determined in step 175 to the at least one node, including the node, e.g. by unicast or by broadcast. If the at least one instruction is further determined based on one or more of network conditions, node capabilities, regulatory requirements, and operator policies in step 175, then the result of step 175 may be that no instructions are transmitted in step 129. Performance of the method of FIG. 6 may then be paused and resumed at a later time, e.g. starting with performing step 151 or step 121 again. Step 103 comprises the node receiving, from the system, the instruction to provide sensing feedback.

A step 189 comprises the node determining additional sensing feedback of the indicated type (indicated in the instruction received in step 103). If sensing-related information was received, e.g. in step 161, the additional sensing feedback may be determined according to the sensing-related information in step 189. If the node, while determining the initial sensing feedback in step 187, obtained information that it did not include in the initial sensing feedback, it may retrieve this information, or part thereof, in step 189.

In step 189, the node may process raw data stored in step 185 to determine additional sensing feedback of the indicated type, optionally using (additional) sensing-related information received from the system. The additional sensing feedback may comprise, for example, IQ samples of the detected echoes/reflections and/or results of local sensing, e.g. a probability of detection, a probability of false-alarm, and/or object attributes (e.g. shape, orientation) if the probability of detection exceeds a threshold.

Step 105 comprises the node transmitting the additional sensing feedback of the indicated type to the system. Step 131 comprises the system receiving the additional sensing feedback from the at least one node, including the node.

Step 125 may be repeated after step 131. In this next iteration of step 125, step 125 comprises the system determining whether the sensing requirements obtained in step 121 can be met when the sensing result is determined based on at least the additional sensing feedback received in step 131 (and optionally based on previously received sensing feedback(s)). If so, then step 133 is performed. The outputted sensing result is then based on at least the additional sensing feedback received in step 131.

Steps 127-131 are repeated if it is determined in step 125 that the sensing requirements cannot be met when the sensing result is determined based on at least the additional sensing feedback received in step 131. Steps 127-131 may be repeated one time or multiple times, e.g. until no further improvement on the sensing result is expected through further feedback. In these next iterations of steps 127-131, the at least one node to which the at least one instruction is transmitted might or might not include the node (to which the at least one instruction was transmitted in the first iteration of steps 127-131).

The node repeats steps 103-105 one or more times if the node is instructed to transmit additional sensing feedback multiple times. If step 125 is not repeated after step 131 (not at all or not another time), step 133 is performed after step 131. A step 191 comprises the node removing the raw data from the memory after a predetermined amount of time (e.g. by using a pre-configured timer) or upon receiving a release instruction e.g. from the system.

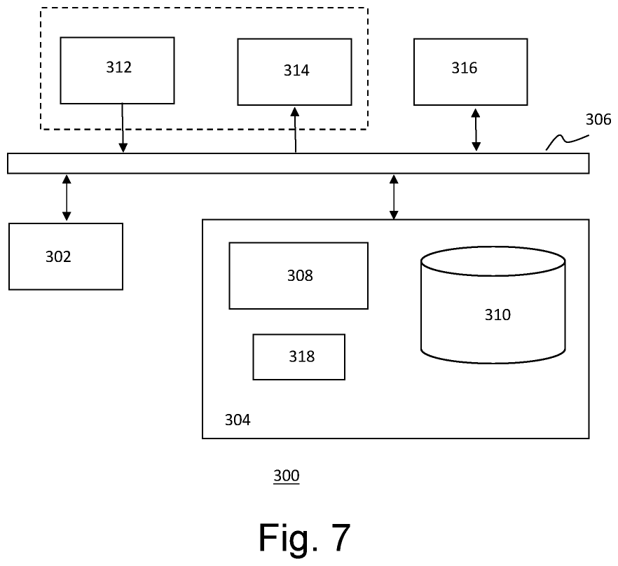

FIG. 7 depicts a block diagram illustrating an exemplary data processing system that may perform the method as described with reference to FIGS. 3-6.

As shown in FIG. 7, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the number of times program code must be retrieved from the bulk storage device 310 during execution.

Input/output (I/O) devices depicted as an input device 312 and an output device 314 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 7 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 7, the memory elements 304 may store an application 318. In various embodiments, the application 318 may be stored in the local memory 308, he one or more bulk storage devices 310, or separate from the local memory and the bulk storage devices. It should be appreciated that the data processing system 300 may further execute an operating system (not shown in FIG. 7) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope of the present invention. The embodiments were chosen and described in order to best explain the principles and some practical applications of the present invention, and to enable others of ordinary skill in the art to understand the present invention for various embodiments with various modifications as are suited to the particular use contemplated.

1. A node for participating in sensing, the node including at least one processor configured to:
receive wireless signals for the purpose of sensing, the received wireless signals comprising received versions of the wireless signals as transmitted,
receive, from a system for sensing, an instruction to provide sensing feedback, the instruction indicating a type of sensing feedback requested from the node, and
transmit sensing feedback of the indicated type to the system for sensing, the sensing feedback being determined based on the received wireless signals.

2. A node as claimed in claim 1, wherein the sensing feedback is additional sensing feedback and the at least one processor is configured to transmit initial sensing feedback preceding the additional sensing feedback to the system for sensing.

3. A node as claimed in claim 2, wherein the at least one processor is configured to:
receive, from the system for sensing, an initial instruction to provide the initial sensing feedback, the initial instruction indicating an initial type of sensing feedback requested from the node, and
transmit the initial sensing feedback by transmitting initial sensing feedback of the indicated initial type.

4. A node as claimed in claim 2, wherein the at least one processor is configured to:
store raw data representative of the received wireless signals in a memory,
determine the sensing feedback based on the stored raw data, and
remove the raw data from the memory after a predetermined amount of time or upon receiving a release instruction.

5. A node as claimed in claim 2, wherein the initial sensing feedback includes one or more flags indicative of the type of sensing feedback which can be obtained from the node.

6. A node as claimed in claim 5, wherein the at least one processor is configured to determine the one or more flags based on at least one of: a processing load of the node, a battery level of the node, capabilities of the node, the strength of the received wireless signals, and the availability of sensing-related information.

7. A node as claimed in claim 1, wherein the at least one processor is configured to:
receive sensing-related information from the system for sensing, and
receive the wireless signals according to the sensing-related information and/or determine the sensing feedback based on the received wireless signals according the sensing-related information.

8. A node as claimed in claim 7, wherein the sensing-related information is indicative of at least one of: one or more thresholds, a sensing window, transmission times of the wireless signals, one or more waveforms of the wireless signals, locations of nodes which transmit the wireless signals, and data relating to one or more target areas collected by other sensors.

9. A system for sensing, the system including at least one processor configured to:
obtain sensing requirements for sensing,
receive sensing feedback from each of a set of nodes,
determine whether the sensing requirements can be met when a sensing result is determined based on the received sensing feedback, and
if the sensing requirements cannot be met when the sensing result is determined based on the received sensing feedback, determine at least one instruction for at least one node of the set of nodes based on the sensing requirements and the received sensing feedback, transmit the at least one instruction to the at least one node, the at least one instruction requesting additional sensing feedback from the at least one node and indicating a type of additional sensing feedback requested from the at least one node, receive the additional sensing feedback from the at least one node, and determine the sensing result based on at least the additional sensing feedback.

10. A system as claimed in claim 9, wherein the at least one processor is configured to determine the at least one instruction further based on one or more of network conditions, node capabilities, regulatory requirements, and operator policies.

11. A system as claimed in claim 9, wherein the at least one processor is configured to:
determine initial instructions for at least one node of the set of nodes based on the sensing requirements, the initial instructions requesting the sensing feedback from the at least one node,
transmit the initial instructions to the at least one node, and
receive the sensing feedback from the at least one node in response to the initial instructions.

12. A system as claimed in claim 9, wherein the sensing feedback received from a respective node of the set of nodes includes one or more flags indicative of the type of sensing feedback which can be obtained from the respective node and the at least one processor is configured to determine the at least one instruction based on the sensing requirements and the one or more flags.

13. A system as claimed in claim 9, wherein the at least one processor is configured to transmit sensing-related information to at least one node of the set of nodes.

14. A method of participating in sensing, the method including:
receiving wireless signals for the purpose of sensing, the received wireless signals comprising received versions of the wireless signals as transmitted;
receiving, from a system for sensing, an instruction to provide sensing feedback, the instruction indicating a type of sensing feedback requested from the node; and
transmitting sensing feedback of the indicated type to the system for sensing, the sensing feedback being determined based on the received wireless signals.

15. A method of sensing, the method including:
obtaining sensing requirements for sensing;
receiving sensing feedback from each of a set of nodes;
determining whether the sensing requirements can be met when a sensing result is determined based on the received sensing feedback; and
if the sensing requirements cannot be met when the sensing result is determined based on the received sensing feedback, determining at least one instruction for at least one node of the set of nodes based on the sensing requirements and the received sensing feedback, transmitting the at least one instruction to the at least one node, the at least one instruction requesting additional sensing feedback from the at least one node and indicating a type of sensing feedback requested from the at least one node, receiving the additional sensing feedback from the at least one node, and determining the sensing result based on at least the additional sensing feedback.

16. A computer program or suite of computer programs comprising at least one software code portion or a computer program product storing at least one software code portion, the software code portion, when run on a computer system, being configured for performing the method of claim 14.
